(19) United States
(12) Patent Application Publication
(10) Pub. No.: US 2026/0295812 A1
(43) Pub. Date: Oct. 1, 2026

(54) SPACE ROBOT AND METHOD OF CONTROLLING A SPACE ROBOT

(71) Applicant: Deutsches Zentrum für Luft- und Raumfahrt e.V., Bonn (DE)

(72) Inventors: Ria VIJAYAN, Oberpfaffenhofen-Weßling (DE); Marco DE STEFANO, Oberpfaffenhofen-Weßling (DE); Christian OTT, Oberpfaffenhofen-Weßling (DE)

(73) Assignee: Deutsches Zentrum für Luft- und Raumfahrt e.V., Bonn (DE)

(21) Appl. No.: 19/573,935

(22) Filed: Mar. 20, 2026

(30) Foreign Application Priority Data
Mar. 21, 2025 (DE) 10 2025 111 079.4

(51) Int. Cl. B25J 9/06; B25J 9/16; B64G 1/10; B64G 1/24

(52) U.S. Cl. CPC B25J 9/06; B25J 9/1607; B25J 9/1633; B25J 9/1669; B64G 1/1078; B64G 1/244

(57) ABSTRACT

A space robot has at least one satellite base, at least one redundant manipulator attached to the satellite base, and at least one control device for controlling the at least one manipulator and the at least one satellite base. The control device is configured to provide a unified controller that takes into account constraints by means of quadratic programming (QP), and also uses a controller with nullspace projection that decouples the movement of at least a part of the manipulator, preferably the end effector, from the positional configuration of the satellite base.

### CROSS-REFERENCE TO RELATED APPLICATIONS

This application claims foreign priority under 35 U.S.C. § 119 to German Patent Application No. DE 10 2025 111 079.4, filed on Mar. 21, 2025, the entire disclosure of which is incorporated herein by reference.

### BACKGROUND OF THE DISCLOSURE

### 1. Field of the Disclosure

The disclosure relates to a space robot and a method for controlling a space robot.

### 2. Description of Related Art

Space robots are used in various space applications, in particular for capturing, grasping, and stabilizing objects in orbit. Such systems can be used for the maintenance, repair, or recovery of satellites and spacecraft.

Existing solutions present various challenges. For example, detected objects can exhibit uncontrolled movement or rotational dynamics, which makes stabilization more difficult. In addition, controlling the robotic arms in zero gravity involves additional degrees of freedom and kinematic constraints. In many cases, the control of the robotic arms depends on the movement of the satellite base, which reduces the precision of grasping and stabilizing.

Another challenge with known systems is that interaction forces between the robotic arm and the grasped object can lead to high loads at the grasping interface, which increases the risk of damage. Furthermore, existing control systems are often limited by constraints on available engine power and fuel resources, which makes efficient control necessary. The object of the disclosure is to provide an improved space robot that enables efficient control for approaching, grasping, and stabilizing an object in orbit.

### SUMMARY OF THE DISCLOSURE

The object is achieved by a space robot having a satellite base, a redundant manipulator attached to the satellite base, and a control device for controlling the redundant manipulator and the satellite base. The control device is configured to provide a unified controller that takes into account constraints using quadratic programming and uses a controller with nullspace projection that decouples movement of at least a portion of the redundant manipulator from a positional configuration of the satellite base.

The object is also achieved by a method of controlling a space robot having at least one satellite base and at least one redundant manipulator attached to the satellite base. The method includes controlling the at least one manipulator and the at least one satellite base using a unified controller that takes into account constraints using quadratic programming and uses a controller with nullspace projection that decouples a movement of at least a portion of the redundant manipulator from a positional configuration of the satellite base.

The disclosure advantageously provides for the control device to provide a unified control system that takes into account both constraints by means of quadratic programming (QP) and uses a controller with nullspace projection. This ensures that the movement of at least a part of the manipulator can be controlled independently of the positional configuration of the satellite base.

The manipulator can comprise an end effector and have at least two joints, wherein the manipulator can preferably be configured as a robotic arm.

The control device can be configured to use a unified controller both in the approach phase and in the post-grasp stabilization phase of the manipulator for approaching, grasping, and stabilizing an object located in space.

Mission-relevant constraints, such as the limitation of interaction forces at the grasping interface or torque limits of the thrusters, can be taken into account by quadratic programming (QP) within the nullspace projection.

The control device can be configured to control the movement of at least the part of the manipulator during the approach phase independently of the positional configuration of the satellite base.

The control device can be configured to control the movement of at least the part of the manipulator and the satellite base in the post-grasp stabilization phase independently of the interaction forces at the grasping interface.

The control device can be configured to explicitly limit interaction forces at the grasping interface by quadratic programming (QP) without using force-torque sensors.

The control device can be configured to ensure the stabilization of an object held in the post-grasp stabilization phase, while the nullspace stabilizes the satellite base independently of the limitation of the interaction forces.

The control device can be configured to take into account torque limits of the thrusters for the distribution of torques between thrusters and reaction wheels by means of quadratic programming (QP) in order to minimize fuel consumption in the approach phase.

The control device can be configured to take into account the torque limits of the thrusters for the distribution of torques between thrusters and reaction wheels by means of quadratic programming (QP) in order to minimize the external impulse in the post-grasp stabilization phase.

The control device can be configured to compute interaction forces and torques at the grasping interface without these being measured by force-torque sensors.

The control device can be configured to apply impedance control within the controller with nullspace projection for tracking motion tasks in nullspace coordinates according to the following equation:

$$\begin{matrix}T 1 : \\ T 2 : \\ T 3 :\end{matrix} {\underbrace{[ \begin{matrix}{F}_{e}^{′} \\ {F}_{n}^{′} \\ {F}_{r}^{′}\end{matrix} ]}}_{{F}^{′}} = {Λ}^{′} [ \begin{matrix}{\dot{v}}_{e}^{d} \\ {\ddot{q}}_{n}^{d} \\ 0\end{matrix} ] + {μ}^{′} [ \begin{matrix}{v}_{e}^{d} \\ {\dot{q}}_{n}^{d} \\ 0\end{matrix} ] + [ \begin{matrix}{EK}_{Pe} Δ {x}_{e} + {K}_{De} Δ {v}_{e} \\ {K}_{Pn} Δ {q}_{n} \to {K}_{Dn} Δ {\dot{q}}_{n} \\ 0\end{matrix} ]$$

wherein Λ′ and μ′ are nullspace decoupled inertia and Coriolis matrices that have the form of a lower triangular block matrix, E transforms the quaternion-based error to a wrench.

The control device can transform the impedance control into system actuator coordinates according to the following equation:

$$Γ = {\underbrace{{J}_{e}^{T} {F}_{e}^{′}}}_{{Γ}_{T 1}} + {\underbrace{{\overline{J}}_{n}^{T} {F}_{n}^{′}}}_{{Γ}_{T 2}} + {\underbrace{{\overline{J}}_{r}^{T} {F}_{r}^{′}}}_{{Γ}_{T 3}} + {Γ}_{μ}$$

wherein the last term is a nullspace Coriolis term for the strict decoupling of tasks.

The control device can be configured to perform a quadratic optimization (QP) for limiting the interaction forces in the post-grasp stabilization phase according to the following equation:

$${min}_{{F}_{e}^{*}} \frac{1}{2} {( {F}_{e}^{*} - {F}_{e}^{′} )}^{T} {Q}_{c} ( {F}_{e}^{*} - {F}_{e}^{′} )$$

$$s . t . {\vert {F}_{c} \vert}_{i} \leq {F}_{c , {max}_{i}}$$

$${v}_{e}^{T} ( {F}_{e}^{*} - {EK}_{Pe} Δ {x}_{e} ) < 0 ,$$

where contact force is computed analytically as a function of the force acting on the end effector according to the following equation:

$${F}_{c} = {( I + {Λ}_{ee} {Λ}_{cc}^{- 1} )}^{- 1} {F}_{e}^{*} + f ( {v}_{s} , {v}_{c} )$$

wherein Λ′ₑₑ and Λ′_{cc} take into account the inertia of the least one part of the manipulator and the held object at the grasping interface.

The control device can be configured to perform a quadratic optimization (QP) for distributing and limiting the thruster torques according to the following equation:

$${min}_{{F}_{r}^{*}} \frac{1}{2} {( \overline{Γ} + {\overline{J}}_{r}^{T} {F}_{r}^{*} )}^{T} {Q}_{Γ} ( \overline{Γ} + {\overline{J}}_{r}^{T} {F}_{r}^{*} )$$

$$s . t . {\vert {τ}_{b} \vert}_{i} \leq {τ}_{b , {max}_{i}} .$$

$$wherein$$

$$\overline{Γ} = {Γ}_{T 1} + {Γ}_{T 2} + {Γ}_{μ}$$

and the thruster torque from the task of the reaction wheels is computed as follows

$${τ}_{b} = {S}_{b} ( \overline{Γ} + {\overline{J}}_{r}^{T} {F}_{r}^{*} )$$

and wherein S_{b} is a selection matrix that selects the thruster torque from the complete control vector in system coordinates.

The space robot can also have at least one sensor device that is used to detect the position and orientation of the satellite base, the joint angles of the manipulator, and the position of the grasping point of an object in space.

According to the disclosure, a method of controlling a space robot (1) having at least one satellite base (B) and at least one redundant manipulator (M) attached to the satellite base (B) can further be provided, comprising the steps of: controlling the at least one manipulator and the at least one satellite base, in which it is advantageously provided that a unified controller is provided which both takes into account constraints by means of quadratic programming (QP) and uses a controller with nullspace projection that decouples the movement of at least a part of the manipulator, from the positional configuration of the satellite base.

The unified controller can be used both in the approach phase and in the post-grasp stabilization phase of the manipulator for approaching, grasping, and stabilizing an object located in space.

The control device can be configured to explicitly limit interaction forces at the grasping interface by quadratic programming (QP) without using force-torque sensors.

### BRIEF DESCRIPTION OF THE DRAWINGS

In the following, embodiments of the disclosure are described in more detail with reference to the Figures.

FIG. 1 shows a schematic illustration of a space robot.

FIG. 2 shows a control device.

FIG. 3 shows a sequence of computations for the first stage.

FIG. 4 shows a sequence of computations for the second stage.

### DETAILED DESCRIPTION OF THE DISCLOSURE

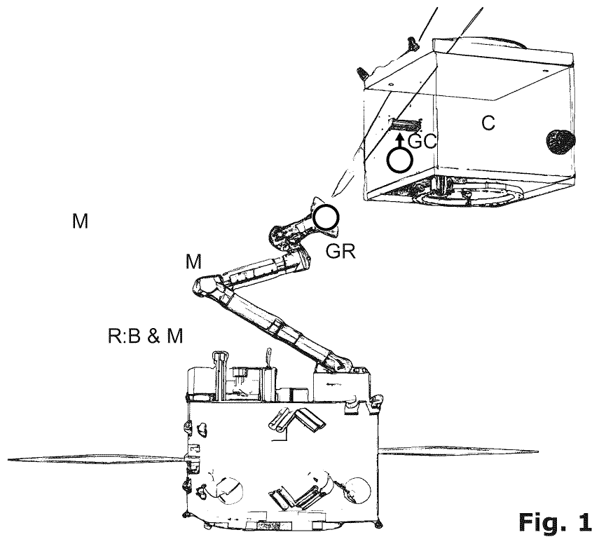

FIG. 1 shows a schematic illustration of a space robot 1 comprising at least one satellite base B with at least one redundant manipulator M attached to the satellite base B. The space robot 1 can be used to approach an object C in space, grasp it, and stabilize it. An object C located in space can be a satellite, as shown, and is also called client satellite C in the following.

Client satellite C is in close proximity to space robot 1 at the start of the approach phase. A space robot grasping interface GR is available on space robot 1, and a client grasping interface GC is also available on client satellite C.

The space robot grasping interface GR can be a standardized interface, and the client grasping interface can be a generic interface (GC), such as a launch adapter ring, which is typically part of most satellite structures.

FIG. 1 shows the general application scenario for so-called on-orbit servicing. The space robot 1, also referred to below as the servicer, comprises the satellite base B, which can be equipped with actuation systems, such as thrusters and reaction wheels, as well as at least one redundant manipulator M with at least two joints. The manipulator M can be a robotic arm.

The illustrated manipulator M is actuated via at least seven internal torque commands (one per joint), while the satellite base B is controlled via at least six external forces/torques of the thrusters and three internal torques of the reaction wheels. The servicer B is also equipped with at least one sensor device S, which is used to detect the position and orientation of the satellite base, the joint angles of the manipulator M, and the position of the grasping point of the customer satellite C.

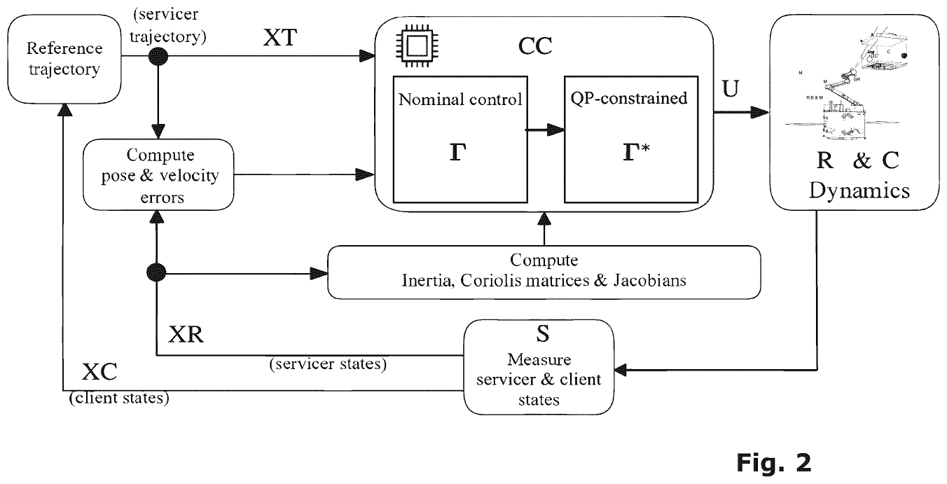

FIG. 2 shows a control device CC. The control device CC is configured to provide a unified controller that takes into account constraints by means of quadratic programming (QP) and uses a controller with nullspace projection that decouples the movement of at least a part of the manipulator, preferably the end effector, from the positional configuration of the satellite base.

The control device CC reacts to measurements from the sensor device S regarding the states of the space robot XR and the states of the client satellite XC. The reference trajectory signal generator XT and the sensor measurements form the control error, on the basis of which the control computer CC computes the control signals U for the space robot 1.

The embodiment of the disclosure shown in FIG. 2 comprises the space robot 1 and the control device CC. In response to status signals XR, XC, which are measured by the sensor device S, and the reference trajectory signal generator XT, the control device CC of the space robot 1 computes the control signals U for the joint motors of the manipulator M and for the thrusters and reaction wheels of the satellite base B.

The control design is standardized for both phases—the approach phase and the post-grasp stabilization phase. A primary Cartesian task is assigned to the end effector T1 in order to initially enable tracking of the customer satellite's grasping point and later stabilization.

A secondary task T2 is defined at the joint level of the manipulator M in order to ensure manipulability and to achieve a safe configuration of the satellite base B in the post-grasp phase.

A third task, T3, uses the redundancy in the basic actuation to distribute control between the thrusters and reaction wheels, thereby optimizing fuel consumption.

The tasks are executed in a fixed priority sequence, wherein the nullspace hierarchy is defined as follows:
T2 is executed in the nullspace of T1,
T3 is executed in the nullspace of T2.

This task hierarchy enables a safe approach and reliable grasping of a rotating satellite, as the control levels are clearly separated and optimized.

The tasks of the subsystems during the approach and post-grasp phase can be described as follows:

### t1 (End Effector)

Approach phase: The end effector tracks the customer satellite's grasp point.
Post-grasp phase: The customer satellite is stabilized, while the interaction forces at the end effector are limited.
   T2 (manipulator joints)
Approach phase: The joint path of the manipulator is tracked in order to achieve a suitable pose for grasping.
Post-grasp phase: The joint speeds are damped to achieve a safe configuration.

### t3 (Reaction Wheels)

Approach phase: The reaction wheels are used to minimize the use of the thrusters.
Post-grasp phase: The external impulse generated by capturing is dissipated by the actuation of the thrusters.

The computation of the control input (U) from the standardized framework in FIG. 2 substantially comprises two stages:
a) computing a nominal control input based on an impedance design with decoupled nullspace dynamics in task coordinates, and
b) then computing the QP-optimized control input that contains the side conditions.

Such a design can be applied more generally for task definitions other than those described in Table 1 if a relationship between the side conditions and the task coordinates can be established to limit the output of the QP optimizer.

The relevant steps in a step-by-step algorithm for the control device CC of FIG. 2 for computing the control signal U can be as follows:

This is the only entry for the R&C system from the standardized control framework for the approach and post-grasp phase.

Algorithm Computing Unified Control Law

Require: Kinematics, dynamics and measured states of servicer

| | |
|---|---|
| | (R) and client (C) |
| 1: | Compute decoupled nullspace inertia and Coriolis matrices |
| | (Λ′, μ′) in task coordinates |
| 2: | Compute Coriolis decoupling (Γ_{μ}) |
| 3: | Compute nominal control law (F′ and Γ) |
| 4: | if phase = post-grasp then |
| 5: | Optimize end-effector wrench (F_{c}*) to limit interaction |
| | forces |
| 6: | end if |
| 7: | Optimize torque distribution between reaction wheels and |
| | thrusters (Fᵣ*) to limit thruster torques |
| 8: | Compute optimized control law in actuator coordinates Γ* |
| | (replace ${F}_{e}^{′} , {F}_{r}^{′} with {F}_{e}^{*} , {F}_{r}^{*} )$ |

### SYMBOLS AND NOTATIONS

•^{d} Relates to desired trajectory
Δ• Error from desired trajectory
•ₙ Relates to manipulator joints
•ᵣ Relates to reaction wheels
•_{b} Relates to servicer's base
•ₛ Relates to servicer (base+reaction wheels+nanipulator)
•ₑ Relates to end-effector
•_{c} Relates to client satellite
•^{•} QP-optimized quantity
•ₘₐₓ Maximum threshold of quantity
K_{P•} Proportional gain
K_{D•} Derivative gain
F′_{•} Virtual control
J_{•} Task Jacobian matrix
J̅_{•} Nullspace-projected task Jacobian matrix
J_{N} Stacked nullspace-projected task Jacobian matrices
Λ′ Nullspace decoupled inertia matrix
μ′ Nullspace decoupled Coriolis matrix
v_{•} Cartesian velocity (linear and angular)
q_{•} Joint position
x_{•} Pose (position and quaternion)
Q_{•} QP weighting matrix
F_{c} Interaction force transmitted to client
τ_{b} Base thruster torques
Γ Control input to servicer (S) including, thruster wrench and reaction wheel torques to base (B), and joint torques to manipulator (R).

For a better understanding of the disclosure and its applicability to a real scenario, further details of the control are described in the following section. In particular, from the proposed scheme in FIG. 2, the left block (control with nullspace projection) and the green block (constraints by means of quadratic programming (QP)) are now elaborated with additional details, which are summarized as follows.

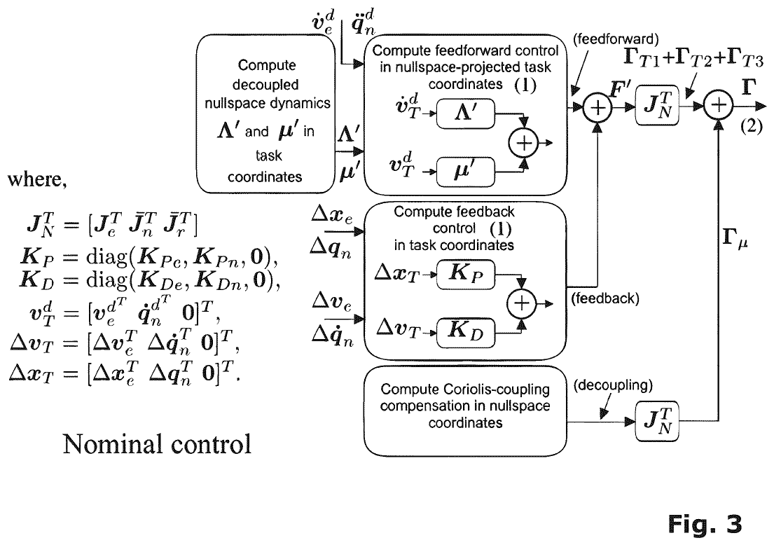

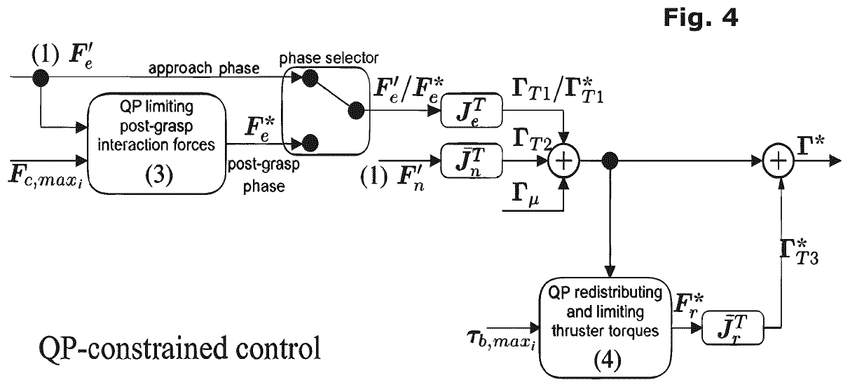

The first stage of the computation control with nullspace projection is embodied by the equations (1) and (2). The second stage of the computation of the QP-bound controller is contained in equations (3) and (4). The sequence of computations for the implementation of equations (1) and (2) is also summarized in the block diagram in FIG. 3, and similarly for equations (3) and (4) in FIG. 4.

| | Eq. |
|---|---|
| Overview of relevant equations and description | # |
| Impedance control law for tracking in nullspace task coordinates | (1) |
| (c.f. Table 1 for control objectives): | |
| $\begin{matrix}T 1 : \\ T 2 : \\ T 3 :\end{matrix} {\underbrace{[ \begin{matrix}{F}_{e}^{′} \\ {F}_{n}^{′} \\ {F}_{r}^{′}\end{matrix} ]}}_{{F}^{′}} = {Λ}^{′} [ \begin{matrix}{\dot{v}}_{e}^{d} \\ {\ddot{q}}_{n}^{d} \\ 0\end{matrix} ] + {μ}^{′} [ \begin{matrix}{v}_{e}^{d} \\ {\dot{q}}_{n}^{d} \\ 0\end{matrix} ] + [ \begin{matrix}{EK}_{Pe} Δ {x}_{e} + {K}_{De} Δ {v}_{e} \\ {K}_{Pn} Δ {q}_{n} + {K}_{Dn} Δ {\dot{q}}_{n} \\ 0\end{matrix} ]$ | |
| where, Λ′ and μ′ are nullspace decoupled inertia and Coriolis matrices | |
| that have a lower-triangular block matrix form. E transforms the | |
| quaternion-based error to a wrench. | |
| Impedance control law transformed to system actuator coordinates: | (2) |
| $Γ = {\underbrace{{J}_{e}^{T} {F}_{e}^{′}}}_{{Γ}_{T 1}} + {\underbrace{{\overline{J}}_{n}^{T} {F}_{n}^{′}}}_{{Γ}_{T 2}} + {\underbrace{{\overline{J}}_{r}^{T} {F}_{r}^{′}}}_{{Γ}_{T 3}} + {Γ}_{μ}$ | |
| where the last term is a nullspace Corilios term for strict decoupling | |
| of tasks. | |
| T1: QP optimization of end-effector task to limit interaction forces | (3) |
| in post- | |
| ${min}_{{F}_{e}^{*}} \frac{1}{2} {( {F}_{e}^{*} - {F}_{e}^{′} )}^{T} {Q}_{c} ( {F}_{e}^{*} - {F}_{e}^{′} )$ $s . t . {\vert {F}_{c} \vert}_{i} \leq {F}_{c , {max}_{i}}$ ${v}_{e}^{T} ( {F}_{e}^{*} - {EK}_{Pe} Δ {x}_{e} ) < 0 ,$ | |
| grasp phase: | |
| where the contact force is computed analytically as a function of | |
| the end-effector wrench, | |
| Here, Λ′ₑₑ and Λ′_{cc} are the inertia of the servicer's end-effector and | |
| client satellite projected at the grasp interface. | |
| ${F}_{c} = {( I + {Λ}_{ee} {Λ}_{cc}^{- 1} )}^{- 1} {F}_{e}^{*} + f ( {v}_{s} , {v}_{c} )$ | |
| T3: QP optimization of reaction wheel task to redistribute and limit | (4) |
| thruster torques: | |
| ${min}_{{F}_{r}^{*}} \frac{1}{2} {( \overline{Γ} + {\overline{J}}_{e}^{T} {F}_{r}^{*} )}^{T} {Q}_{Γ} ( \overline{Γ} + {\overline{J}}_{r}^{T} {F}_{r}^{*} )$ $s . t . {\vert {τ}_{b} \vert}_{i} \leq {τ}_{b , {max}_{i}} .$ $\overline{Γ} = {Γ}_{T 1} + {Γ}_{T 2} + {Γ}_{μ}$ | |
| where, | |
| and thruster torque is computed from the reaction wheel task using | |
| the relation, | |
| ${τ}_{b} = {S}_{b} ( \overline{Γ} + {\overline{J}}_{r}^{T} {F}_{r}^{*} )$ | |
| S_{b} is the appropriate selector matrix that selects the thruster torque | |
| out of the full control vector in system coordinates | |

What is claimed is:

1. A space robot, comprising
a satellite base;
a redundant manipulator attached to the satellite base; and
a control device for controlling the redundant manipulator and the satellite base,
wherein the control device is configured to provide a unified controller that takes into account constraints using quadratic programming and uses a controller with nullspace projection that decouples movement of at least a portion of the redundant manipulator from a positional configuration of the satellite base.

2. The space robot according to claim 1, wherein the redundant manipulator has at least a portion thereof that comprises an end effector.

3. The space robot according to claim 1, wherein the redundant manipulator has at least two joints.

4. The space robot according to claim 1, wherein the redundant manipulator is a robotic arm.

5. The space robot according to claim 1, wherein the control device is configured to use the unified controller in both an approach phase and in a post-grasp stabilization phase to approach, grasp, and stabilize an object located in space.

6. The space robot according to claim 1, wherein the control device is configured to take into account one or more mission-relevant constraints using quadratic programming within the nullspace projection.

7. The space robot according to claim 1, wherein the control device is configured to control movement of the at least a portion of the redundant manipulator during an approach phase independently of a positional configuration of the satellite base.

8. The space robot according to claim 1, wherein the control device is configured to control movement of the at least a portion of the redundant manipulator and the satellite base in a post-grasp stabilization phase independently of interaction forces at a grasping interface.

9. The space robot according to claim 1, wherein the control device is configured to explicitly limit interaction forces at a grasping interface using quadratic programming without using force-torque sensors.

10. The space robot according to claim 1, wherein the control device is configured to stabilize an object during a post-grasp stabilization phase while the nullspace stabilizes the satellite base independently of a limitation of interaction forces.

11. The space robot according to claim 1, wherein the control device is configured to take into account torque limits of thrusters for a distribution of torques between thrusters and reaction wheels using quadratic programming in order to minimize fuel consumption in an approach phase.

12. The space robot according to claim 1, wherein the control device is configured to take into account torque limits of thrusters for a distribution of torques between thrusters and reaction wheels using quadratic programming in order to minimize an external impulse in a post-grasp stabilization phase.

13. The space robot according to claim 1, wherein the control device is configured to compute interaction forces and torques at a grasping interface without these being measured by force-torque sensors.

14. The space robot according to claim 1, wherein the control device applies impedance control in the controller with nullspace projection for tracking motion tasks in nullspace coordinates according to the following equation:
$$\begin{matrix}T 1 : \\ T 2 : \\ T 3 :\end{matrix} {\underbrace{[ \begin{matrix}{F}_{e}^{′} \\ {F}_{n}^{′} \\ {F}_{r}^{′}\end{matrix} ]}}_{{F}^{′}} = {Λ}^{′} [ \begin{matrix}{\dot{v}}_{e}^{d} \\ {\ddot{q}}_{n}^{d} \\ 0\end{matrix} ] + {μ}^{′} [ \begin{matrix}{v}_{e}^{d} \\ {\dot{q}}_{n}^{d} \\ 0\end{matrix} ] + [ \begin{matrix}{EK}_{Pe} Δ {x}_{e} + {K}_{De} Δ {v}_{e} \\ {K}_{Pn} Δ {q}_{n} \to {K}_{Dn} Δ {\dot{q}}_{n} \\ 0\end{matrix} ] ,$$
wherein Λ′ and μ′ are nullspace decoupled inertia and Coriolis matrices that have the form of a lower triangular block matrix, and E transforms the quaternion-based error to a wrench.

15. The space robot according to claim 14, wherein the control device transforms the impedance control into system actuator coordinates according to the following equation:
$$Γ = {\underbrace{{J}_{e}^{T} {F}_{e}^{′}}}_{{Γ}_{T 1}} + {\underbrace{{\overline{J}}_{n}^{T} {F}_{n}^{′}}}_{{Γ}_{T 2}} + {\underbrace{{\overline{J}}_{r}^{T} {F}_{r}^{′}}}_{{Γ}_{T 3}} + {Γ}_{μ} ,$$
wherein the last term is a nullspace Coriolis term for strict decoupling of tasks.

16. The space robot according to claim 1, wherein the control device is configured to perform a quadratic optimization for limiting interaction forces in a post-grasp stabilization phase according to the following equation:
$${min}_{{F}_{e}^{*}} \frac{1}{2} {( {F}_{e}^{*} - {F}_{e}^{′} )}^{T} {Q}_{c} ( {F}_{e}^{*} - {F}_{e}^{′} )$$
$$s . t . {\vert {F}_{c} \vert}_{i} \leq {F}_{c , {max}_{i}}$$
$${v}_{e}^{T} ( {F}_{e}^{*} - {EK}_{Pe} Δ {x}_{e} ) < 0 ,$$
wherein the contact force is computed analytically as a function of the force acting on an end effector according to the following equation:
$${F}_{c} = {( I + {Λ}_{ee} {Λ}_{cc}^{- 1} )}^{- 1} {F}_{e}^{*} + f ( {v}_{s} , {v}_{c} ) ,$$
wherein Λ′ₑₑ and Λ′_{cc} take into account an inertia of the least one part of the manipulator and a held object at a grasping interface.

17. The space robot according to claim 1, wherein the control device is configured to perform a quadratic optimization for distributing and limiting thruster torques according to the following equation:
$${min}_{{F}_{r}^{*}} \frac{1}{2} {( \overline{Γ} + {\overline{J}}_{r}^{T} {F}_{r}^{*} )}^{T} {Q}_{Γ} ( \overline{Γ} + {\overline{J}}_{r}^{T} {F}_{r}^{*} )$$
$$s . t . {\vert {τ}_{b} \vert}_{i} \leq {τ}_{b , {max}_{i}} .$$
$$wherein$$
$$\overline{Γ} = {Γ}_{T 1} + {Γ}_{T 2} + {Γ}_{μ} ,$$
wherein the thruster torque from the task of the reaction wheels is computed as follows
$${τ}_{b} = {S}_{b} ( \overline{Γ} + {\overline{J}}_{r}^{T} {F}_{r}^{*} ) ,$$
and
wherein Sb is a selection matrix that selects the thruster torque from a complete control vector in system coordinates.

18. A method of controlling a space robot having at least one satellite base and at least one redundant manipulator attached to the satellite base, the method comprising:
controlling the at least one manipulator and the at least one satellite base using a unified controller that takes into account constraints using quadratic programming and uses a controller with nullspace projection that decouples a movement of at least a portion of the redundant manipulator from a positional configuration of the satellite base.

19. The method according to claim 18, further comprising using the unified controller during both an approach phase and a post-grasp stabilization phase of the manipulator to approach, grasp, and stabilize an object located in space.

20. The method according to claim 18, further comprising explicitly limiting interaction forces at a grasping interface using quadratic programming without using force-torque sensors.
